(19) United States
(12) Patent Application Publication
(10) Pub. No.: US 2007/0033035 A1
(43) Pub. Date: Feb. 8, 2007

(54) STRING DISPLAY METHOD AND DEVICE COMPATIBLE WITH THE HINDI LANGUAGE

(76) Inventors: Neeraj Sharma, Panchkula (IN); Arun Gupta, Faridabad (IN)

Correspondence Address: NORTH AMERICA INTELLECTUAL PROPERTY CORPORATION, P.O. BOX 506, MERRIFIELD, VA, 22116, US

(21) Appl. No.: 11/461,774

(22) Filed: Aug. 2, 2006

(30) Foreign Application Priority Data
Aug. 5, 2005 (IN) 2095DEL2005

(51) Int. Cl. G10L 15/06

(52) U.S. Cl. 704/245

(57) ABSTRACT

A string display method is disclosed. The method includes: receiving an input string containing a plurality of characters; grouping the characters into a plurality of clusters according to predetermined cluster formation rules; applying predetermined ligature formation rules to the clusters to generate a resultant string; and then displaying the resultant string to an output device.

### BACKGROUND

The present invention relates to a string display method and related device, and more specifically, to a string display method compatible with the Hindi language and related device.

As is well known by those of average skill in the art, the Hindi language differs from other languages in several ways but especially in the formation of words. Comparing Hindi to English, for example, a simple left-to-right reading of a word is adequate to construct the sounds (i.e., phonemes) that represent the English word. In the Hindi language, however, reordering and reshaping of the characters may occur during this process because the physical representation of the Indic words is different from their pronunciation.

Hindi is written, for example, in the Devanagari script. The writing systems that employ Devanagari and other Indic scripts constitute a cross between syllabic writing systems and phonemic writing systems (i.e., alphabets). The effective unit of these writing systems is the orthographic syllable, consisting of a consonant (C) and vowel (V) core, (C V), and zero or more preceding consonants, with a canonical structure of ((C) C) C V. Please note that the notation of upper case (C) and (C) (V) are used throughout to indicate consonants and vowels. The orthographic syllables need not correspond exactly with a phonological syllable, especially when a consonant cluster is involved, however, the writing system is built on phonological principles and therefore tends to closely correspond to the pronunciation.

As is well known by those of average skill in the art, Devanagari makes extensive use of ligatures. Whenever consonants occur without an intervening vowel, the consonants are written with a ligature. Forms of ligature include these three groups. First, vertical ligatures with the first consonant are appearing above the second consonant. Second, horizontal ligatures with the main vertical stroke omitted on all but the last consonant. Finally, third are special ligatures where the combined form does not resemble the separate consonants. In addition, consonant (R A) is represented specially in combination with other consonants. Consonant (R A) before a consonant cluster is indicated by a mark above the consonant cluster and to the right of any vowel marker. Alternately, the special combination with consonant (R A) after a consonant cluster is indicated by a diagonal tick in the lower left. The presence of these ligatures makes computerization of the Devanagari script nontrivial, however, this tasks is possible.

The orthographic syllable is constructed of alphabetic pieces. The alphabetic pieces are the actual letters of the Devanagari script. The pieces consist of three distinct character types: consonant letters, independent vowels, and dependent vowel signs. In a text sequence, these characters are stored in logical (i.e., phonetic) order.

Devanagari characters, like characters from many other scripts, can combine or change shape depending on their context. A character's appearance is affected by its ordering with respect to other characters, the font used to render the character, and the application or system environment (e.g., a computer system or other electronic platform). These variables can cause the appearance of Devanagari characters to differ from their nominal glyphs (e.g., those used in the standardized code charts). Additionally, a few Devanagari characters cause a change in the order of the displayed characters as mentioned earlier. This reordering is not commonly seen in non-Indic scripts and occurs independently of any bidirectional character reordering that might be required.

Although Indic words are comprised of syllables, a syllabic unit is also an individual visual unit or glyph. In some cases, the glyphs are completely reconstructed. In other cases, visual markers are applied above, below, to the left, and to the right of the glyph. Syllable formation always focuses on a single character regardless of the single character being a conjunct-cluster or otherwise. This single character is referred to as the base or root character. When two characters are combined, their component parts may be rearranged. Sometimes the result is identifiable, but at other times, only a trained eye can identify the resulting form.

It is apparent that the need for real time and highly efficient Hindi and Devanagari script implementation for mobile phone devices is very advantageous. Prior art systems are not able to offer sufficient efficiency required by, for example, mobile phone devices that wish to utilize Hindi and Devanagari script. This is due in part to the minimal processing power available in mobile phone devices and also the bulk of processing required by prior art implementations of Hindi and Devanagari script. For example, the prior art uses a rule table containing a tremendous number of rules, and searching the rule table for a proper rule is time-consuming. Therefore, the prior art is not able to implement Hindi or Devanagari script sufficiently fast for a real time user experience given the well known limitations of processing power offered by mobile phones. Therefore, it is apparent that new and improved methods and devices are needed.

### SUMMARY

It is therefore one of primary objectives of the claimed disclosure to provide a string display method and related device compatible with the Hindi language for implementing Devanagari script.

According to an embodiment of the claimed disclosure, a string display method is disclosed. The method comprises: receiving an input string containing a plurality of characters; grouping the characters into a plurality of clusters according to predetermined cluster formation rules; applying predetermined ligature formation rules to the clusters to generate a resultant string; and displaying the resultant string.

According to another embodiment of the claimed disclosure, a ligature formatting method is disclosed. The method comprises: converting an input string into a resulting string by providing a rule table comprising a plurality of entries, wherein for each character, the rule table contains at least an entry corresponding to the character, where the entry defines that a first string is mapped to a second string, and a first character of the first string is the character; receiving the input string to be processed; for each target unprocessed character in the input string, searching entries corresponding to the target unprocessed character for a target entry having a first string of a maximum number of characters matching a sequence of contiguous characters in the input string where the target character is the first character of the sequence; and then appending a second string of the target entry to the resultant string.

According to another embodiment of the claimed disclosure, a string display device is disclosed. The string display device comprises: a storage device, a microprocessor, and a display device. The storage device comprises: an execution program code, an input buffer, and an output buffer. The input buffer stores an input string containing a plurality of characters, and the output buffer stores a resultant string. The microprocessor, coupled to the storage device, executes the execution program code to group the plurality of characters into a plurality of clusters according to predetermined cluster formation rules, and to apply predetermined ligature formation rules to the clusters to generate the resultant string. Finally, the display device, coupled to the storage device, displays the resultant string.

According to another embodiment of the claimed disclosure, a ligature formatting device is disclosed. The ligature formatting device comprises: a storage device, a execution program code, a microprocessor, and a rule table. The storage device comprises: an input buffer for storing an input string to be processed. The rule table comprises: a plurality of entries, wherein for each character, the rule table contains at least an entry corresponding to the character, where the entry defines that a first string is mapped to a second string, and a first character of the first string is the character. The microprocessor, coupled to the storage device, is for executing the execution program code to search entries corresponding to the target unprocessed character for a target entry having a first string of a maximum number of characters matching a sequence of contiguous characters in the input string where the target character is the first character of the sequence; and then appending a second string of the target entry to the resultant string for each target unprocessed character in the input string.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a cluster formation and ligature formation device according to an embodiment of the present disclosure.

FIGS. 2 through 9 show a flow diagram for cluster formation according to an embodiment of the present disclosure.

FIGS. 10 through 13 show a flow diagram for ligature formation according to an embodiment of the present disclosure.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . . ” The terms “couple” and “couples” are intended to mean either an indirect or a direct electrical connection. Thus, if a first device couples to a second device, that connection may be through a direct electrical connection, or through an indirect electrical connection via other devices and connections.

The present disclosure string display method and device compatible with the Hindi language is implemented in a mobile phone in a preferred embodiment. The preferred embodiment is not intended to suggest any limitation of the present disclosure. The present disclosure string display method and device are not limited to an implementation in a mobile phone.

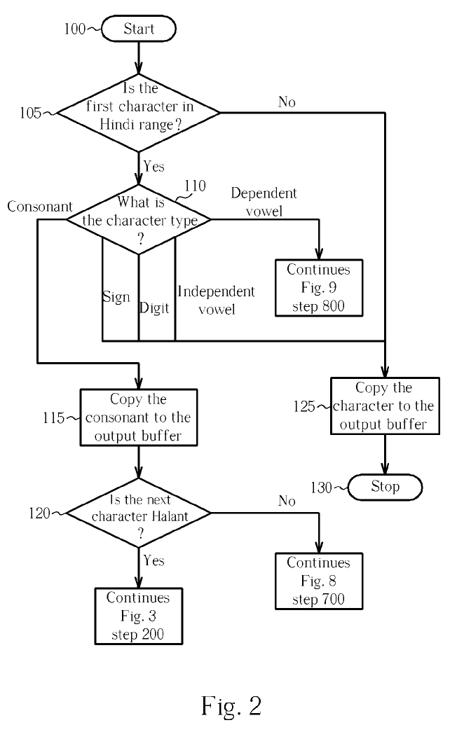

The present disclosure provides highly efficient methods for string display of the Hindi language making full use of the rules associated with the Devanagari script. These rules are detailed in FIGS. 2 through 9. The efficiency of the present disclosure allows string display of the Hindi language in real time, for example, when implemented in an editor or word processor of a mobile phone or other computer system. The present disclosure implements a Hindi rules search algorithm to perform the steps of implementing Devanagari script in real time.

According to an embodiment of the present invention, the task of implementing Hindi or Devanagari Script consists of three primary steps. The first step involves forming clusters of characters from a string of input characters, where characters are reordered if necessary. Once clusters are formed, they are the equivalent of characters in the context of character based languages. The second step involves taking the clusters formed in the first step and then applying rules to the clusters. The applied rules are for facilitating ligature formation. Finally, in the third step, the resulting string from the second step is displayed or otherwise output to an output device or a display device. The display device, for example, takes as input the string after ligatures have been formed and outputs the string with ligatures to a display of a computer, mobile phone, or other similar output device. When implementing Hindi or Devanagari script in a mobile phone device, it is necessary that these steps be performed in real time.

The input to the first step is a string of characters that is to be processed by the present invention. The output of the first step is clusters and the clusters are each output individually as they are processed. Additionally, in the first step, if a character in the input string is not in the Hindi character range then that character is simply returned as output in its unchanged original input form. This method of input and output for the first step is helpful when considering cursor movement within an editor, for example, in a computer system or a mobile phone. During the first step, many cluster formation rules are applied and these formation rules and their application are detailed later.

The input to the second step is the cluster generated by the first step. The output of the second step is a resultant string comprising the cluster in which ligatures have been formed. During the second step, many ligature formation rules are applied and these formation rules and their application are detailed later.

Finally, the resultant string of the second step is passed to a font engine for display in the third step. For example, the font engine can be in a computer or mobile phone operating system. The font engine is responsible for rendering the display of the resultant string. Details of display rendering via the font engine vary among output devices, however, all of these details are well known to those of average skill in this art and are therefore details of their operation are omitted here for the sake of brevity.

The present disclosure increases the speed and efficiency of string display and string entry related to the Hindi language. As noted earlier, this is especially important regarding display and entry for mobile phones. The present disclosure speeds up the process of cluster formation by several folds and can be used in devices where the processors are not very powerful or there is little memory available or both. Additionally, the present disclosure implements approximately 370 rules that comprise an exhaustive knowledge base for the formation of the ligatures generally required while using Hindi or Devanagari. The present disclosure ligature formation, detailed later, is language independent and can be used with other Indic and non-Indic scripts where a few characters can combine to form different characters. In such cases, only the rules table and the map table need to be modified for implementing the new language.

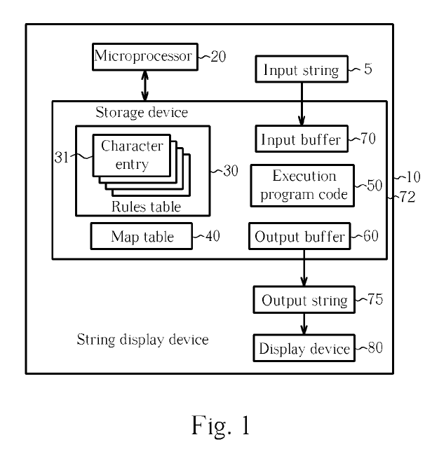

Please refer to FIG. 1. FIG. 1 is a block diagram of a cluster and ligature formation string display device 10 according to an embodiment of the present disclosure. As shown in FIG. 1, the string display device 10 has a storage device 72, a microprocessor 20, and a display device 80. The storage device 72 further comprises an input buffer 70 that receives an input string 5 containing a plurality of characters, an execution program code 50 that is described in more detail later, and an output buffer 60 used for storing a resultant string. Additionally, the storage device 72 contains a rules table 30 and the rules table 30 further comprises a plurality of character entries 31 wherein there is a character entry 31 for each of the characters in the Hindi character range, and each character entry 31 includes at least one entry defining a mapping rule. Finally, the storage device 72 contains a map table 40 and the map table 40 contains a mapping for each Hindi character to its character entry 31 in the rules table 30. Additionally, the map table 40 contains the number of unique rules for each Hindi character and the maximum length of an input string found in the character entry 31 in the rules table 30 associated with the character. A microprocessor 20 is coupled to the storage device 72. The microprocessor 20 is used for executing the execution program code 50 for performing ligature formation to produce a resultant string. The resultant string is the content of the output buffer 60 that is output to a display device 80. The display device 80 is coupled to the storage device 72, and is used to display the output string 75 on a computer or mobile phone or any other similar device.

Please refer to FIG. 2 through FIG. 9. FIG. 2 through FIG. 9 shows a flow diagram for cluster generating algorithm according to an embodiment of the present disclosure. Please note that the maximum cluster size compatible with the present disclosure is determined by the requirements at hand and is in no way limited by the example provided. The cluster formation operation increases the efficiency of the present disclosure. Additionally, the formation of clusters is a generic operation that relies on the classification of characters, for example, consonants, dependent vowels, signs, digits, and so on. Cluster formation is not dependent on the sequence of characters. Existing systems, such as computer system, computer operating systems, and mobile phone operating systems, that already implement systems for string display compatible with, for example, the Hindi language, can easily adopt the cluster formation algorithm because, as will be further detailed later, the formed cluster is equivalent to a character and therefore implicitly compatible with the existing systems. Further, operations in said existing systems that are executed on characters are, in the present disclosure, executed on clusters. For example, cursor movement, word wrapping in text editors, and so on, that are character-based operations, i.e., the cursor/insertion point operates in terms of characters as the smallest measurement, simply utilize the formed cluster as the smallest measurement unit in the context of the present disclosure.

The algorithm for cluster formation is explained below as corresponding to FIG. 2 through FIG. 9. It should be noted that the cluster formation is performed by the microprocessor 20 executing the execution program code 50.

Step 100: Start

Step 105: Is the first character in the Hindi range? If yes, then proceed to step 110. If no, then proceed to step 130.

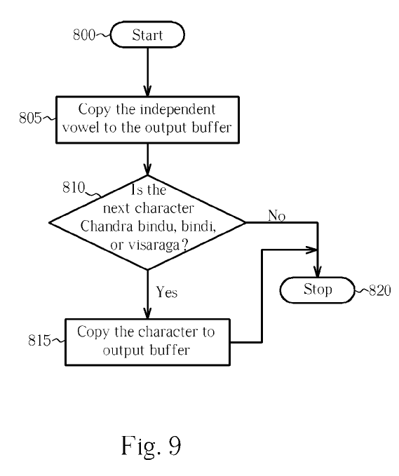

Step 110: What is the character type? If the character type is consonant then go to step 115. If the character type is sign then go to step 130. If the character type is digit then go to step 130. If the character type is independent vowel then go to step 130. If the character type is dependent vowel then go to step 800 of FIG. 9.

Step 115: Copy the consonant to the output buffer 60.

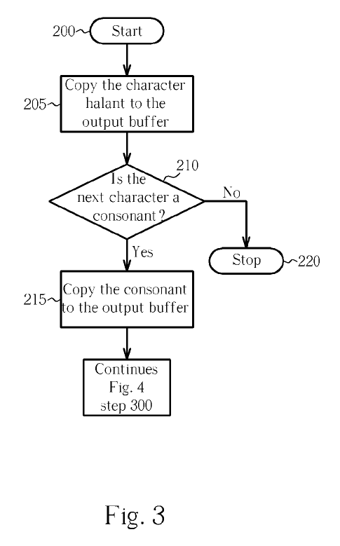

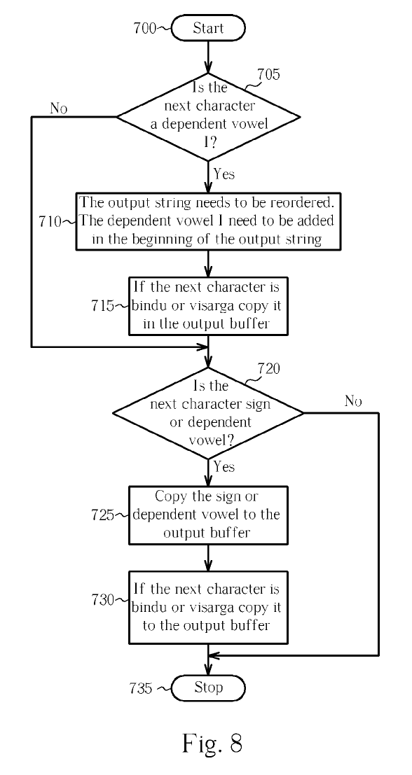

Step 120: Is the next character a halant? If yes then go to step 200 of FIG. 3. If no, then go to step 700 of FIG. 8.

Step 125: Copy the character to the output buffer 60. Note that the output buffer 60 stores each final cluster. Go to step 130.

Step 130: Stop.

Please note in FIG. 2 that characters that are not in the Hindi range of characters are simply copied to the output buffer 60 and thereby form a cluster containing just that non-Hindi character.

Please refer to FIG. 3. FIG. 3 shows a continued flow diagram for cluster generation algorithm according to an embodiment of the present disclosure.

Step 200: Start.

Step 205: Copy the character halant to the output buffer 60.

Step 210: Is the next character a consonant? If yes, then go to step 215 and if no then go to step 220.

Step 215: Copy the consonant to the output buffer. Go to step 300 of FIG. 3.

Step 220: Stop.

Similarly, when the next character is not consonant, the current character halant is simply copied to the output buffer 60 and thereby form a cluster containing just that character.

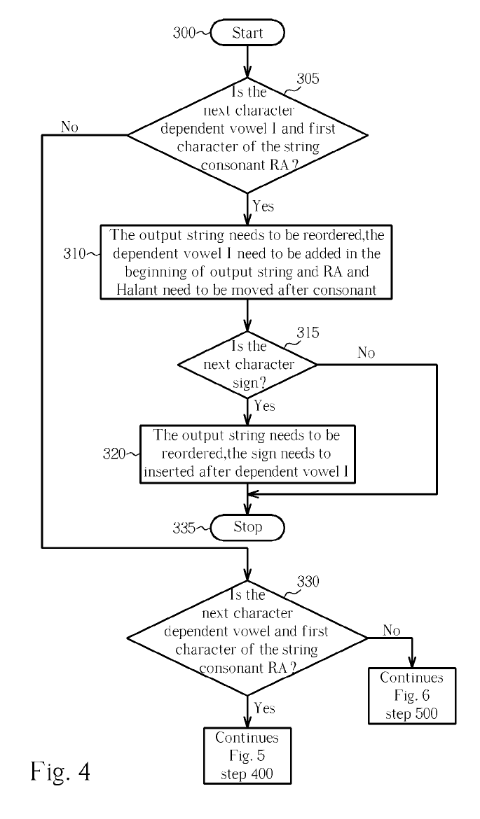

Please refer to FIG. 4. FIG. 4 shows a continued flow diagram for cluster generation algorithm according to an embodiment of the present disclosure.

Step 300: Start.

Step 305: Is the next character the dependent vowel I, and the first character of the string consonant RA? If yes then go to step 310. If no, then go to step 330.

Step 310: Reorder the output string. Move the dependent vowel I to the beginning of the output string 75 and move the consonant RA and the halant after the consonant.

Step 315: If the next character is of type sign then go to step 320 otherwise go to step 335.

Step 320: The output string 75 must be reordered. The sign character must be inserted after the dependent vowel I character. Go to step 335.

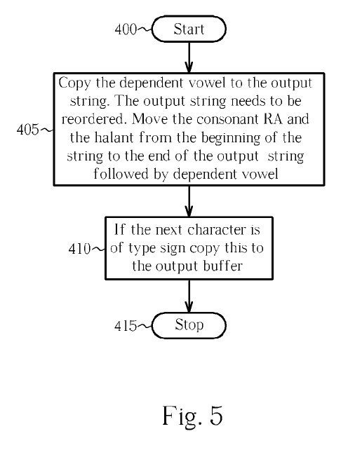

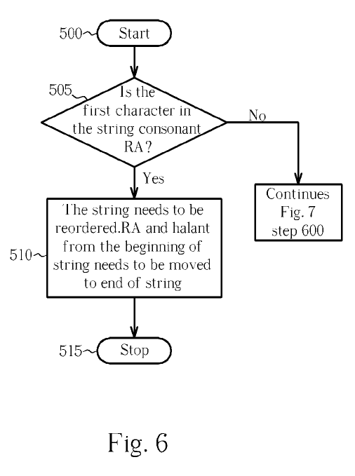

Step 330: Is the next character a sign or dependent vowel and is the first character of the string a consonant RA? If yes, then go to step 400 of FIG. 5 and if no then go to step 500 of FIG. 6.

Step 335: Stop.

Please refer to FIG. 5. FIG. 5 shows a continued flow diagram for cluster generation algorithm according to an embodiment of the present disclosure.

Step 400: Start.

Step 405: Copy the dependent vowel to the output string. The output string 75 must be reordered. Move the consonant RA and the halant from the beginning of the string to the end of the string followed by the dependent vowel.

Step 410: If the next character is of type sign then copy it to the output buffer 60.

Step 415: Stop.

Please refer to FIG. 6. FIG. 6 shows a continued flow diagram for cluster generation algorithm according to an embodiment of the present disclosure.

Step 500: Start.

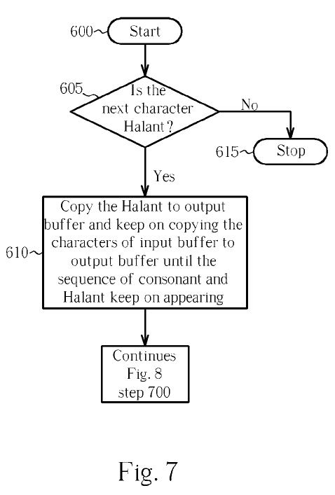

Step 505: Is the first character in the string a consonant RA? If yes then go to step 501; otherwise, go to step 600 of FIG. 7.

Step 510: The output string 75 must be reordered. Move the consonant RA and the halant from the beginning of the string to the end of the string.

Step 515: Stop.

Please refer to FIG. 7. FIG. 7 shows a continued flow diagram for cluster generation algorithm according to an embodiment of the present disclosure.

Step 600: Start.

Step 605: Is the next character a halant? If yes then go to step 610 otherwise go to step 615.

Step 610: Copy the halant to the output buffer and continue copying the characters of the input buffer to the output buffer until the sequence of consonant and halant appear a second time and then go to step 700 of FIG. 8.

Step 615: Stop.

Please refer to FIG. 8. FIG. 8 shows a continued flow diagram for cluster generation algorithm according to an embodiment of the present disclosure.

Step 700: Start.

Step 705: Is the next character a dependent vowel I? If yes then go to step 710 and if no then go to step 720.

Step 710: The output string 75 must be reordered. The dependent vowel I must be added to the beginning of the output string.

Step 715: If the next character is bindu or visarga then copy the character to the output buffer 60.

Step 720: Is the next character a sign or a dependent vowel? If yes then go to step 725 otherwise go to step 735.

Step 725: Copy the sign or dependent vowel to the output buffer 60.

Step 730: If the next character is bindu or visarga then copy the character to the output buffer 60.

Step 735: Stop.

Please refer to FIG. 9. FIG. 9 shows a continued flow diagram for cluster generation algorithm according to an embodiment of the present disclosure.

Step 800: Start.

Step 805: Copy the dependent vowel to the output buffer 60.

Step 810: Is the next character Chandra bindu, bindu, or visaraga? If yes then go to step 815 otherwise go to step 820.

Step 815: Copy the character to the output buffer 60.

Step 820: Stop.

The following example is provided to better highlight the details of the flow of the present invention as shown in FIGS. 2 through 9. Consider that the input string to be processed is, for example:

consonant+dependent vowel I

In this case, the flow begins at step 100 and continues in the following order as shown below:

Step 100, step 110, step 115, step 120, step 705, step 710, step 715, step 720, step 740.

The flow begins with step 100. Next, because the first character is in the Hindi character range the flow proceeds to step 110. Next, step 110 determines that the character is a consonant so the flow proceeds to step 115. In step 115, the character is copied to the output buffer 60. At this point, the output buffer 60 contains: consonant. Next, step 115 flows to step 120 where in step 120 determines that the next character is not a halant so the flow proceeds to step 705. Step 700 flows to step 705 where in step 705 determines that the character is a dependent vowel I resulting in the flow going to step 710 where the dependent vowel I is inserted in the output buffer 60 to ensure that it is at the beginning of the output buffer 60. In other words, the dependent vowel I is prepended to the output buffer 60. At this point, the output buffer 60 contains: (dependent vowel I)+(consonant). Next, in step 720, it is determined that the next character is not a sign or a dependent vowel so the flow proceeds to step 740 where it terminates. Finally, the output buffer 60 contains: (dependent vowel I)+(consonant). It is well known to those of average skill in the art that the present disclosure has correctly reordered the input string 5 according to the rules for the Hindi language. For a preferred embodiment, the ligature formation is required to perform on the generated clusters. However, for some embodiments, the present disclosure can directly show the result of cluster formation. Therefore, the string display device 10 can output the generated cluster in the output buffer 60 as output string 75 for displaying to a display device 80. These alternative designs fall in the scope of the present disclosure.

A second example is provided to better highlight the details of the flow of the present disclosure as shown in FIGS. 2 through 9. Consider that the input string 5 to be processed is, for example:

consonant RA+halant+consonant

Please note that the addition sign indicates that, for example, the halant follows the consonant RA and that the consonant follows the halant. In this case, the flow begins at step 100 and continues in the following order:

Step 100, step 110, step 115, step 120, step 200, step 205, 210, step 215, step 300, step 305, step 330, step 500, step 505, step 510, step 515.

The resulting output buffer 60 is: (consonant)+(consonant RA)+(halant).

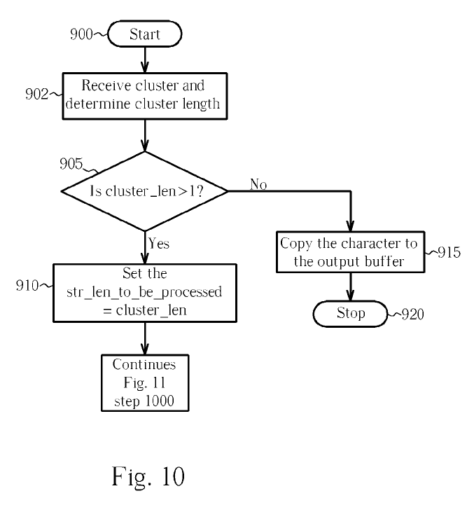

Please refer to FIGS. 10 through 13. FIGS. 10 through 13 show a flow diagram for ligature formation rules according to an embodiment of the present disclosure.

After the formation of the clusters, the next step involved is ligature formation. Please note that the starting index of arrays and string is zero. Also all the string comparisons and string copies do not compare NULL or copy NULL respectively. In the previous steps, the clusters have been formed so that rules can now be applied to each of the clusters. There are approximately 370 rules that need to be applied to each cluster for the ligature formation process. For example, a cluster of size 30 may require applying the rules as many as 15 times. Therefore, in a worst case of the present invention, a single cluster can require as many as 15*370 rule applications. In fact, for each cluster, not all rules are applied. However, it is necessary to know which of the 370 rules must be applied to a given cluster.

This present disclosure increases the efficiency of rule application to the clusters for the process of ligature formation by searching the rule to be applied in the fastest possible way. A rules table 30 is defined as having a separate entry for each character in the Hindi character range. An entry in the rules table 30 is called a character entry 31. Each character entry 31 of the rules table 30 corresponds to a specific Hindi character and consists of at least one entry but can contain more than a single entry. Each entry in the character entry 31 contains the following four parameters: input length INPUT_LEN, output length OUTPUT_LEN, entry input string INTPUT_STR, and entry output string OUTPUT_STR. The entry input length INPUT_LEN defines the length of input string 5 complies with this entry and in this way the present disclosure can determine when the entry is used for ligature formation, the entry output length OUTPUT_LEN defines the length of output string 75 when the mapping rule of the entry is applied, the entry input string INPUT_STR defines the string on which the mapping rule of the entry is applied, and the entry output string OUTPUT_STR defines the string in which ligatures have been formed. Please note that each character has one character entry 31 in the rules table 30. At the very least, a character entry 31 that has a single entry indicates that if that specific character is received in the input string 5 then that same character will be directly copied to the output buffer 60 and no other changes or rules will be applied. This ensures that every character has at least a single rule (i.e., entry) in its corresponding character entry 31 in the rules table 30. This requirement is needed for the correct operation of the rules table 30 and this will become obvious when the ligature formation flow is detailed later in a description of FIGS. 10 through 13.

More specifically, for every character, there are a plurality of rules that are stored in the rules table 30. The rules depend on what other characters may follow the specific character and the sequence in which the characters appear. As mentioned previously, the entry for each character is called the character entry 31 and contains all such rules associated with the given character. Each of the said rules are called an entry (i.e., an entry in the character entry 31). In an embodiment of the present disclosure, the rules are stored in the character entry 31 in ascending order according to the length of the input string parameter. This provides the maximum efficiency in the operation of the present disclosure. However, this is not meant to indicate a limitation of the present disclosure.

In addition to the rules table 30, a map table 40 is utilized. The map table 40 contains the mapping between the character and entries in the corresponding character entry 31, the number of rules (i.e., entries) for the character, and the maximum length of the input string parameter in the entries for the particular character. Note that the maximum length of the input string is determined by checking all of the input string INTPUT_STR lengths for all of the entries and selecting the input string INTPUT_STR having the greatest length and making that value the maximum length. In other words, in this embodiment the microprocessor 20 executes the execution program code 50 to reference the map table 40 to quickly search for a proper entry for a given character.

The ligature formation algorithm for searching the rules table 30 is detailed by FIGS. 10 through 13. The algorithm is language independent, therefore, it can also be used in case of other Indic and non-Indic scripts where a few characters can combine to form different characters. In such cases, only the rules table 30 and the map table 40 must be modified for implementing the new language; no code changes are required to the execution program code 50. Please refer to FIG. 10. FIG. 10 is a flow diagram for ligature formation according to an embodiment of the present disclosure.

Step 900: Start.

Step 902: Receive a cluster and determine the cluster length CLUSTER_LEN of the received cluster.

Step 905: Is the CLUSTER_LEN>1? If yes then go to step 910. If no, then go to step 915.

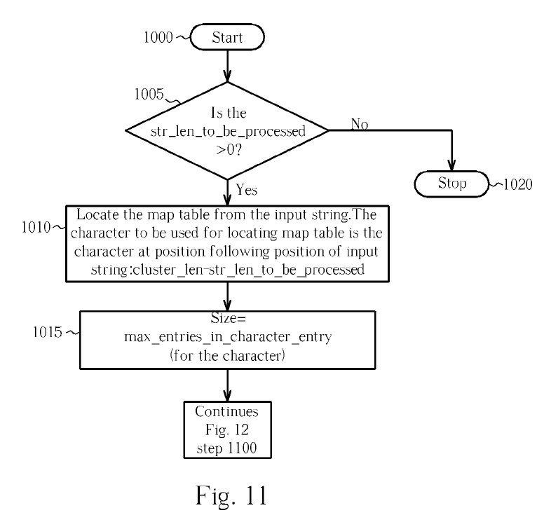

Step 910: Set the STR_LEN_TO_BE_PROCESSED=CLUSTER_LEN. Go to step 1000 of FIG. 11.

Step 915: Copy the character to the output buffer 60. Note that the output buffer 60 stores each final cluster. Go to step 920.

Step 920: Stop.

Please refer to FIG. 11. FIG. 11 is a continued flow diagram for ligature formation according to an embodiment of the present disclosure.

Step 1000: Start.

Step 1005: Is the STR_LEN_TO_BE_PROCESSED>0? If yes, then go to step 1010. If no, then go to step 1020.

Step 1010: Locate the map table according to the character of the input string in a specific character position. The specific character position is determined by the result of the calculation: CLUSTER_LEN−STR_LEN_TO_BE_PROCESSED.

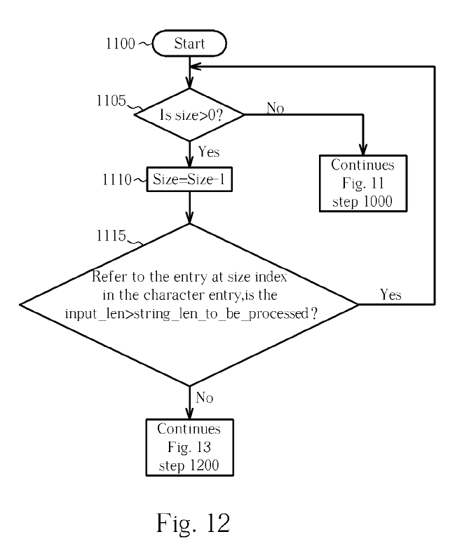

Step 1015: Set SIZE=MAX_ENTRIES_IN_CHARACTER_ENTRY (for the character). Go to step 1100 of FIG. 12.

Step 1020: Stop.

Please refer to FIG. 12. FIG. 12 is a continued flow diagram for ligature formation according to an embodiment of the present disclosure.

Step 1100: Start.

Step 1105: Is SIZE>0? If yes then go to step 1110. If no then go to step 1000 of FIG. 11.

Step 1110: Set SIZE=SIZE−1

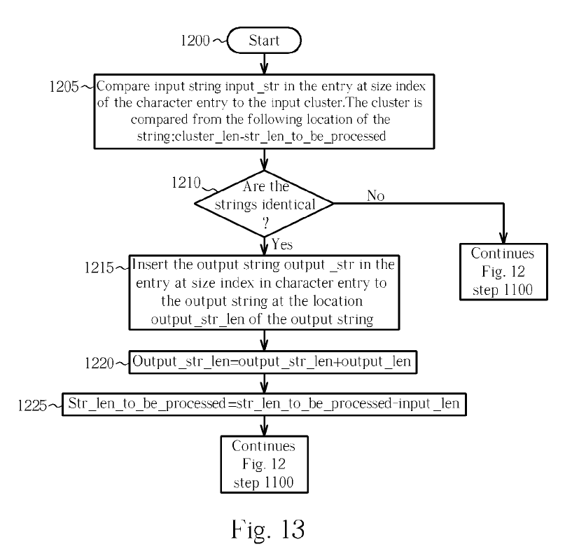

Step 1115: Reference the entries for the character entry 31 of the rules table 30 for the character according to the value of SIZE (i.e., the entry pointed to by the value of SIZE) and determine if the input length INPUT_LEN>STRING_LEN_TO_BE_PROCESSED? If yes, then go to step 1105. If no, then go to step 1200 of FIG. 13.

Please refer to FIG. 13. FIG. 13 is a continued flow diagram for ligature formation according to an embodiment of the present invention.

Step 1200: Start.

Step 1205: Access the entry located at index SIZE of the character entry 31 of the rules table 30 and compare the input string INPUT_STR of the entry with a portion of the input cluster starting with the character of the input cluster at location: CLUSTER LEN−STR_LEN_TO_BE_PROCESSED.

Step 1210: Are the strings identical? If yes, then go to step 1215. If no, then go to step 1100 of FIG. 12.

Step 1215: Access the entry located at SIZE of the character entry 31 of the rules table 30 and insert the output string OUTPUT_STR of the entry at a position of the output string 75 according to a position index OUTPUT_STR_LEN.

Step 1220: Set OUTPUT_STR_LEN=OUTPUT_STR_LEN+OUPUT_LEN associated with the inserted entry output string OUTPUT_STR in step 1215.

Step 1225: Set STR_LEN_TO_BE_PROCESSED=STR_LEN_TO_BE_PROCESSED−INPUT_LEN associated with the inserted entry output string OUTPUT_STR in step 1215. Go to step 1100 of FIG. 12.

The following example is provided to better highlight the details of the flow of the present disclosure as shown in FIGS. 10 through 13. Consider that the input string to be processed is, for example:

(DEPENDENT VOWEL I)+(CONSONANT KA)+(HALANT)+(CONSONANT SSA)

Also, for this example the following entry for consonant KA in the rules table is given as:

[Consonant KA Table Start]

[Entry 1 Start]

Input Len: 1

Output Len: 1

Input String: C_KA

Output String: C_KA

[Entry 1 End]

[Entry 2 Start]

Input Len: 3

Output Len: 1

Input String: C_KA, S_HALANT,C_SSA

Output String: L_KSHA

[Entry 2 End]

[Consonant KA Table End]

Also, for this example the following entry for dependent vowel I in the rules table is given as:

[Dependent Vowel I Table Start]

[Entry 1 Start]

Input Len: 1

Output Len: 1

Input String: DV_I

Output String: DV_I

[Entry 1 End]

[DEPENDENT VOWEL I TABLE END]

The output for the input given above is:

(DEPENDENT VOWEL I)+(LIGATURE KSHA) Please note, the consonant KA+halant+consonant SSA joined together to form the ligature KSHA.

Please note that the addition sign indicates that, for example, the halant follows the consonant KA. In this case, the flow begins at step 900 and continues in the following order:

Step 900, step 910, step 1005, step 1010, step 1015, step 1110, step 1115, step 1205, step 1210, step 1215, step 1220, step 1225, step 1005, step 1010, step 1015, step 1105, step 1110, step 1115, step 1205, step 1210, step 1220, step 1225, step 1005.

Please consider another example to illustrate how the present disclosure increases performance. Consider, for example, a cluster is:

C₁, H, C₂, H, C₃, H, . . . , C_{N},H

where C₁ is consonant 1, C₂ is consonant 2, C₃ is consonant 3, . . . , C_{N} is consonant 15 and H is Halant.

For example, if the system consists of M rules then the number of rules to be searched in this case without using the present disclosure is (N*(M/2)). Please note that in this example, N is 15 (i.e., maximum cluster size of 30), and M is 370. As a result, the rules to be searched is (370*15)=5,550.

Continuing with this example, now consider how the present disclosure improves performance whereby the worst-case number of rules to be searched is:

R₁+R₂+R₃, . . . , +R_{N}

where R₁ is the number of entries in rules table 30 for the consonant 1, R₂ is the number of entries in the rules table 30 for the consonant 2, and R_{N} is the number of entries in the rules table for the consonant N.

In the worst case the size of R_{N} is 32, therefore, the number of rules to be searched is (32*15)=480. Please note, this is true for N=15. In the worst case example, the increase in speed provided by the present disclosure is (5550/480)=11.5 times speed up.

Finally, the resultant string stored in the output buffer 60 is output by the string display device 10 as the output string 75. The output string 75 can be passed to a font engine (not shown) for display to the display device 80. All details of Hindi font display are well known to those of average skill in the art and are therefore omitted for the sake of brevity. Note that the present disclosure does not limit the display device 80 to being disposed on a mobile phone or a computer.

In summary, the present disclosure string display device 10 offers faster and more efficient real-time implementation of the Hindi language and Devanagari script.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A string display method comprising:
receiving an input string containing a plurality of characters;
grouping the characters into a plurality of clusters according to predetermined cluster formation rules;
applying predetermined ligature formation rules to the clusters to generate a resultant string; and
displaying the resultant string.

2. The method of claim 1, wherein the step of grouping the characters into the clusters comprises:
if a target character to be processed is not a Hindi character, generating a cluster including the target character only.

3. The method of claim 1, wherein the step of grouping the characters into the clusters comprises:
if a target character to be processed is a Hindi character and not a consonant or a dependent vowel, generating a cluster including the target character only.

4. The method of claim 1, wherein the step of grouping the characters into the clusters comprises:
if a target character to be processed is a Hindi character and a consonant, a first character following the target character is a Hindi character and a Halant, and a second character following the first character is a Hindi character and a consonant, generating a cluster sequentially including the target character, the first character, and the second character.

5. The method of claim 1, wherein the step of grouping the characters into the clusters comprises:
if a target character to be processed is a Hindi character and a consonant, a first character following the target character is a Hindi character and a Halant, and a second character following the first character is a Hindi character and not a consonant, generating a cluster sequentially including the target character and the first character.

6. The method of claim 1, wherein the step of grouping the characters into the clusters comprises:
if a target character to be processed is a Hindi character and a consonant, a first character following the target character is a Hindi character and a dependent vowel I, a second character following the first character is bindu or visargra, and a third character following the second character is a Hindi character and not a sign or a dependent vowel, generating a cluster sequentially including the first character, the target character, and the second character.

7. The method of claim 1, wherein the step of grouping the characters into the clusters comprises:
if a target character to be processed is a Hindi character and a consonant, a first character following the target character is a Hindi character and a dependent vowel I, a second character following the first character is not bindu, visargra, sign, or dependent vowel, generating a cluster sequentially including the first character and the target character.

8. The method of claim 1, wherein the step of grouping the characters into the clusters comprises:
if a target character to be processed is a Hindi character and a consonant, a first character following the target character is a Hindi character and a dependent vowel I, reversing the order of the target character and the first character; and
if a second character following the first character is bindu or visargra, a third character following the second character is a Hindi character and a sign or a dependent vowel, a fourth character following the third character is bindu or visarga, generating a cluster sequentially including the first character, the target character, the second character, the third character, and the fourth character.

9. The method of claim 1, wherein the step of grouping the characters into the clusters comprises:
if a target character to be processed is a Hindi character and a consonant, a first character following the target character is a Hindi character and a dependent vowel I, reversing the order of the target character and the first character; and
if a second character following the first character is bindu or visargra, a third character following the second character is a Hindi character and a sign or a dependent vowel, a fourth character following the third character is not bindu or visarga, generating a cluster sequentially including the first character, the target character, the second character, and the third character.

10. The method of claim 1, wherein the step of grouping the characters into the clusters comprises:
if a target character to be processed is a Hindi character and a consonant, a first character following the target character is a Hindi character and a dependent vowel I, reversing the order of the target character and the first character; and
if a second character following the first character is not bindu, visargra and is a sign or a dependent vowel, and a third character following the second character is bindu or visarga, generating a cluster sequentially including the first character, the target character, the second character, and the third character.

11. The method of claim 1, wherein the step of grouping the characters into the clusters comprises:
if a target character to be processed is a Hindi character and a consonant, a first character following the target character is a Hindi character and a dependent vowel I, reversing the order of the target character and the first character; and
if a second character following the first character is not bindu, visargra and is a sign or a dependent vowel, and a third character following the second character is not bindu or visarga, generating a cluster sequentially including the first character, the target character, and the second character.

12. The method of claim 1, wherein the step of grouping the characters into the clusters comprises:
if a target character to be processed is a Hindi character and a consonant, a first character following the target character is a Hindi character and a sign or a dependent vowel, and a second character following the first character is bindu or visarga, generating a cluster sequentially including the target character, the first character, and the second character.

13. The method of claim 1, wherein the step of grouping the characters into the clusters comprises:
if a target character to be processed is a Hindi character and a consonant, a first character following the target character is a Hindi character and a sign or a dependent vowel, and a second character following the first character is not bindu or visarga, generating a cluster sequentially including the target character and the first character.

14. The method of claim 1, wherein the step of grouping the characters into the clusters comprises:
if a target character to be processed is a Hindi character and a dependent vowel consonant, and a first character following the target character is chandra_bindu, bindu, or visarga, generating a cluster sequentially including the target character and the first character.

15. The method of claim 1, wherein the step of grouping the characters into the clusters comprises:
if a target character to be processed is a Hindi character and a dependent vowel consonant, and a first character following the target character is not chandra_bindu, bindu, or visarga, generating a cluster including the target character only.

16. The method of claim 1, wherein the step of grouping the characters into the clusters comprises:
if a target character to be processed is a Hindi character and a consonant, a first character following the target character is a Hindi character and a Halant, and a second character following the first character is not a consonant, generating a cluster sequentially including the target character and the first character.

17. The method of claim 1, wherein the step of grouping the characters into the clusters comprises:
if a target character to be processed is a Hindi character and a consonant, a first character following the target character is a Hindi character and a Halant, and a second character following the first character is a consonant, a third character following the second character is a Hindi character and a dependent vowel I, the target character is a consonant RA, and a fourth character following the third character is not a sign, generating a cluster sequentially including the third character, the second character, the target character, and the first character.

18. The method of claim 1, wherein the step of grouping the characters into the clusters comprises:
if a target character to be processed is a Hindi character and a consonant, a first character following the target character is a Hindi character and a Halant, and a second character following the first character is a consonant, a third character following the second character is a Hindi character and a dependent vowel I, the target character is a consonant RA, and a fourth character following the third character is a sign, generating a cluster sequentially including the third character, the fourth character, the second character, the target character, and the first character.

19. The method of claim 1, wherein the step of grouping the characters into the clusters comprises:
if a target character to be processed is a Hindi character and a consonant, a first character following the target character is a Hindi character and a Halant, and a second character following the first character is a consonant, a third character following the second character is a Hindi character and a dependent vowel, the target character is a consonant RA, and a fourth character following the third character is a sign, generating a cluster sequentially including the second character, the target character, the first character, the third character, and the fourth character.

20. The method of claim 1, wherein the step of grouping the characters into the clusters comprises:
if a target character to be processed is a Hindi character and a consonant, a first character following the target character is a Hindi character and a Halant, and a second character following the first character is a consonant, a third character following the second character is a Hindi character and a dependent vowel, the target character is a consonant RA, and a fourth character following the third character is not a sign, generating a cluster sequentially including the second character, the target character, the first character, and the third character.

21. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, and the target character is a consonant RA, generating a cluster sequentially including the second character, the target character, and the first character.

22. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent, generating a cluster sequentially including the target character, the first character, the second character, and the third character, and appending a plurality of characters following the third character to the cluster until the sequence of consonant and Halent appears a second time;
if a fourth character immediately following the appended characters following the third character is a Hindi character and a dependent vowel I, a fifth character following the fourth character is bindu or visargra, and a sixth character following the fifth character is not a sign or a dependent vowel, prepending the fourth character to the cluster and appending the fifth character to the cluster.

23. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent, generating a cluster sequentially including the target character, the first character, the second character, and the third character, and appending a plurality of characters following the third character to the cluster until the sequence of consonant and Halent appears a second time;
if a fourth character immediately following the appended characters following the third character is a Hindi character and a dependent vowel I, a fifth character following the fourth character is not bindu, visargra, sign, or dependent vowel, prepending the fourth character to the cluster.

24. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent, generating a cluster sequentially including the target character, the first character, the second character, and the third character, and appending a plurality of characters following the third character to the cluster until the sequence of consonant and Halent appears a second time;
if a fourth character immediately following the appended characters following the third character is a Hindi character and a dependent vowel I, a fifth character following the fourth character is bindu or visargra, a sixth character following the fifth character is a Hindi character and a sign or a dependent vowel, a seventh character following the sixth character is bindu or visarga, prepending the fourth character to the cluster, and appending the fifth character, the sixth character, and the seventh character to the cluster.

25. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent, generating a cluster sequentially including the target character, the first character, the second character, and the third character, and appending a plurality of characters following the third character to the cluster until the sequence of consonant and Halent appears a second time;
if a fourth character immediately following the appended characters following the third character is a Hindi character and a dependent vowel I, a fifth character following the fourth character is bindu or visargra, a sixth character following the fifth character is a Hindi character and a sign or a dependent vowel, a seventh character following the sixth character is not bindu or visarga, prepending the fourth character to the cluster, and appending the fifth character, and the sixth character to the cluster.

26. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent, generating a cluster sequentially including the target character, the first character, the second character, and the third character, and appending a plurality of characters following the third character to the cluster until the sequence of consonant and Halent appears a second time;
if a fourth character immediately following the appended characters following the third character is a Hindi character and a sign or dependent vowel, and a fifth character following the fourth character is bindu or visargra, appending the fourth character and the fifth character to the cluster.

27. The method of claim 1, wherein the step of grouping the characters into the clusters comprises:
if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent, generating a cluster sequentially including the target character, the first character, the second character, and the third character, and appending a plurality of characters following the third character to the cluster until the sequence of consonant and Halent appears a second time;
if a fourth character immediately following the appended characters following the third character is a Hindi character and a sign or a dependent vowel, and a fifth character following the fourth character is not bindu or visargra, appending the fourth character to the cluster.

28. The method of claim 1, wherein the step of generating the resultant string comprises:
receiving a cluster to be processed and determining a cluster length of the received cluster; and
if the cluster length is not greater than one, appending a character of the received cluster to the resultant string.

29. The method of claim 1, wherein the step of generating the resultant string comprises:
providing a rule table comprising a plurality of entries, wherein for each Hindi character, the rule table contains at least an entry corresponding to the Hindi character, where the entry defines that a first string is mapped to a second string, and a first character of the first string is the Hindi character;
receiving a cluster to be processed;
when processing a target unprocessed character in the received cluster, searching entries corresponding to the target unprocessed character for a target entry having a first string of a maximum number of characters matching a sequence of contiguous characters in the cluster where the target character is the first character of the sequence; and
appending a second string of the target entry to the resultant string.

30. The method of claim 29, wherein the step of searching entries corresponding to the target character for the target entry comprises:
excluding entries each having a first string containing more characters than a sum of unprocessed characters in the cluster.

31. The method of claim 1, wherein the resultant string complies with Devanagari Script.

32. A ligature formatting method for converting an input string into a resulting string, comprising:
providing a rule table comprising a plurality of entries, wherein for each character, the rule table contains at least an entry corresponding to the character, where the entry defines that a first string is mapped to a second string, and a first character of the first string is the character;
receiving the input string to be processed;
for each target unprocessed character in the input string, searching entries corresponding to the target unprocessed character for a target entry having a first string of a maximum number of characters matching a sequence of contiguous characters in the input string where the target character is the first character of the sequence; and then appending a second string of the target entry to the resultant string.

33. The method of claim 32, wherein the step of searching entries corresponding to the target character for the target entry comprises:
excluding entries each having a first string containing more characters than a sum of unprocessed characters in the input string.

34. A string display device comprising:
a storage device comprising an execution program code, an input buffer for storing an input string containing a plurality of characters, and an output buffer for storing a resultant string;
a microprocessor, coupled to the storage device, for executing the execution program code to group the plurality of characters into a plurality of clusters according to predetermined cluster formation rules, and to apply predetermined ligature formation rules to the clusters to generate the resultant string; and
a display device, coupled to the storage device, for displaying the resultant string.

35. The string display device of claim 34, wherein the microprocessor executes the execution program code to generate a cluster including a target character only, if the target character to be processed is not a Hindi character.

36. The string display device of claim 34, wherein the microprocessor executes the execution program code to generate a cluster including a target character only, if the target character to be processed is a Hindi character and not a consonant or a dependent vowel.

37. The string display device of claim 34, wherein the microprocessor executes the execution program code to generate a cluster sequentially including the target character, the first character, and the second character, if a target character to be processed is a Hindi character and a consonant, a first character following the target character is a Hindi character and a Halant, and a second character following the first character is a Hindi character and a consonant.

38. The string display device of claim 34, wherein the microprocessor executes the execution program code to generate a cluster sequentially including the target character and the first character, if a target character to be processed is a Hindi character and a consonant, a first character following the target character is a Hindi character and a Halant, and a second character following the first character is a Hindi character and not a consonant.

39. The string display device of claim 34, wherein the microprocessor executes the execution program code to generate a cluster sequentially including the first character, the target character, and the second character, if a target character to be processed is a Hindi character and a consonant, a first character following the target character is a Hindi character and a dependent vowel I, a second character following the first character is bindu or visargra, and a third character following the second character is a Hindi character and not a sign or a dependent vowel.

40. The string display device of claim 34, wherein the microprocessor executes the execution program code to generate a cluster sequentially including the first character and the target character, if a target character to be processed is a Hindi character and a consonant, a first character following the target character is a Hindi character and a dependent vowel I, a second character following the first character is not bindu, visargra, sign, or dependent vowel.

41. The string display device of claim 34, wherein the microprocessor executes the execution program code to reverse the order of the target character and the first character, if a target character to be processed is a Hindi character and a consonant, a first character following the target character is a Hindi character and a dependent vowel I; and
the microprocessor executes the execution program code to generate a cluster sequentially including the first character, the target character, the second character, the third character, and the fourth character, if a second character following the first character is bindu or visargra, a third character following the second character is a Hindi character and a sign or a dependent vowel, a fourth character following the third character is bindu or visarga.

42. The string display device of claim 34, wherein the microprocessor executes the execution program code to reverse the order of the target character and the first character, if a target character to be processed is a Hindi character and a consonant, a first character following the target character is a Hindi character and a dependent vowel I; and
the microprocessor executes the execution program code to generate a cluster sequentially including the first character, the target character, the second character, and the third character, if a second character following the first character is bindu or visargra, a third character following the second character is a Hindi character and a sign or a dependent vowel, a fourth character following the third character is not bindu or visarga.

43. The string display device of claim 34, wherein the microprocessor executes the execution program code to reverse the order of the target character and the first character, if a target character to be processed is a Hindi character and a consonant, a first character following the target character is a Hindi character and a dependent vowel I; and
the microprocessor executes the execution program code to generate a cluster sequentially including the first character, the target character, the second character, and the third character, if a second character following the first character is not bindu, visargra and is a sign or a dependent vowel, and a third character following the second character is bindu or visarga.

44. The string display device of claim 34, wherein the microprocessor executes the execution program code to reverse the order of the target character and the first character, if a target character to be processed is a Hindi character and a consonant, a first character following the target character is a Hindi character and a dependent vowel I; and
the microprocessor executes the execution program code to generate a cluster sequentially including the first character, the target character, and the second character, if a second character following the first character is not bindu, visargra and is a sign or a dependent vowel, and a third character following the second character is not bindu or visarga.

45. The string display device of claim 34, wherein the microprocessor executes the execution program code to generate a cluster sequentially including the target character, the first character, and the second character, if a target character to be processed is a Hindi character and a consonant, a first character following the target character is a Hindi character and a sign or a dependent vowel, and a second character following the first character is bindu or visarga.

46. The string display device of claim 34, wherein the microprocessor executes the execution program code to generate a cluster sequentially including the target character and the first character, if a target character to be processed is a Hindi character and a consonant, a first character following the target character is a Hindi character and a sign or a dependent vowel, and a second character following the first character is not bindu or visarga.

47. The string display device of claim 34, wherein the microprocessor executes the execution program code to generate a cluster sequentially including the target character and the first character, if a target character to be processed is a Hindi character and a dependent vowel consonant, and a first character following the target character is chandra_bindu, bindu, or visarga.

48. The string display device of claim 34, wherein the microprocessor executes the execution program code to generate a cluster including the target character only, if a target character to be processed is a Hindi character and a dependent vowel consonant, and a first character following the target character is not chandra_bindu, bindu, or visarga.

49. The string display device of claim 34, wherein the microprocessor executes the execution program code to generate a cluster sequentially including the target character and the first character, if a target character to be processed is a Hindi character and a consonant, a first character following the target character is a Hindi character and a Halant, and a second character following the first character is not a consonant.

50. The string display device of claim 34, wherein the microprocessor executes the execution program code to generate a cluster sequentially including the third character, the second character, the target character, and the first character, if a target character to be processed is a Hindi character and a consonant, a first character following the target character is a Hindi character and a Halant, and a second character following the first character is a consonant, a third character following the second character is a Hindi character and a dependent vowel I, the target character is a consonant RA, and a fourth character following the third character is not a sign.

51. The string display device of claim 34, wherein the microprocessor executes the execution program code to generate a cluster sequentially including the third character, the fourth character, the second character, the target character, and the first character, if a target character to be processed is a Hindi character and a consonant, a first character following the target character is a Hindi character and a Halant, and a second character following the first character is a consonant, a third character following the second character is a Hindi character and a dependent vowel I, the target character is a consonant RA, and a fourth character following the third character is a sign.

52. The string display device of claim 34, wherein the microprocessor executes the execution program code to generate a cluster sequentially including the second character, the target character, the first character, the third character, and the fourth character, if a target character to be processed is a Hindi character and a consonant, a first character following the target character is a Hindi character and a Halant, and a second character following the first character is a consonant, a third character following the second character is a Hindi character and a dependent vowel, the target character is a consonant RA, and a fourth character following the third character is a sign.

53. The string display device of claim 34, wherein the microprocessor executes the execution program code to generate a cluster sequentially including the second character, the target character, the first character, and the third character, if a target character to be processed is a Hindi character and a consonant, a first character following the target character is a Hindi character and a Halant, and a second character following the first character is a consonant, a third character following the second character is a Hindi character and a dependent vowel, the target character is a consonant RA, and a fourth character following the third character is not a sign.

54. The string display device of claim 34, wherein the microprocessor executes the execution program code to generate a cluster sequentially including the second character, the target character, and the first character, if a target character to be processed is a Hindi character and a consonant, a first character following the target character is a Hindi character and a Halant, a second character following the first character is a Hindi character and a consonant, and the target character is a consonant RA.

55. The string display device of claim 34, wherein the microprocessor executes the execution program code to generate a cluster sequentially including the target character, the first character, the second character, and the third character, and appending a plurality of characters following the third character to the cluster until the sequence of consonant and Halent appears a second time, if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent; and
the microprocessor executes the execution program code to prepend the fourth character to the cluster and appending the fifth character to the cluster, if a fourth character immediately following the appended characters following the third character is a Hindi character and a dependent vowel I, a fifth character following the fourth character is bindu or visargra, and a sixth character following the fifth character is not a sign or a dependent vowel.

56. The string display device of claim 34, wherein the microprocessor executes the execution program code to generate a cluster sequentially including the target character, the first character, the second character, and the third character, and appending a plurality of characters following the third character to the cluster until the sequence of consonant and Halent appears a second time, if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent; and
the microprocessor executes the execution program code to prepend the fourth character to the cluster, if a fourth character immediately following the appended characters following the third character is a Hindi character and a dependent vowel I, a fifth character following the fourth character is not bindu, visargra, sign, or dependent vowel.

57. The string display device of claim 34, wherein the microprocessor executes the execution program code to generate a cluster sequentially including the target character, the first character, the second character, and the third character, and appending a plurality of characters following the third character to the cluster until the sequence of consonant and Halent appears a second time, if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent; and
the microprocessor executes the execution program code to prepend the fourth character to the cluster, and appending the fifth character, the sixth character, and the seventh character to the cluster, if a fourth character immediately following the appended characters following the third character is a Hindi character and a dependent vowel I, a fifth character following the fourth character is bindu or visargra, a sixth character following the fifth character is a Hindi character and a sign or a dependent vowel, a seventh character following the sixth character is bindu or visarga.

58. The string display device of claim 34, wherein the microprocessor executes the execution program code to generate a cluster sequentially including the target character, the first character, the second character, and the third character, and appending a plurality of characters following the third character to the cluster until the sequence of consonant and Halent appears a second time, if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent; and
the microprocessor executes the execution program code to prepend the fourth character to the cluster, and then append the fifth character, and the sixth character to the cluster, if a fourth character immediately following the appended characters following the third character is a Hindi character and a dependent vowel I, a fifth character following the fourth character is bindu or visargra, a sixth character following the fifth character is a Hindi character and a sign or a dependent vowel, a seventh character following the sixth character is not bindu or visarga.

59. The string display device of claim 34, wherein the microprocessor executes the execution program code to generate a cluster sequentially including the target character, the first character, the second character, and the third character, and appending a plurality of characters following the third character to the cluster until the sequence of consonant and Halent appears a second time, if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent; and
the microprocessor executes the execution program code to append the fourth character and the fifth character to the cluster, if a fourth character immediately following the appended characters following the third character is a Hindi character and a sign or dependent vowel, and a fifth character following the fourth character is bindu or visargra.

60. The string display device of claim 34, wherein the microprocessor executes the execution program code to generate a cluster sequentially including the target character, the first character, the second character, and the third character, and appending a plurality of characters following the third character to the cluster until the sequence of consonant and Halent appears a second time, if a target character to be processed is a Hindi character and a consonant, a first character following the target character is a Hindi character and a Halant, a second character following the first character is a Hindi character and a consonant, the target character is not a consonant RA, and a third character following the second character is a Hindi character and a Halent; and
the microprocessor executes the execution program code to append the fourth character to the cluster, if a fourth character immediately following the appended characters following the third character is a Hindi character and a sign or a dependent vowel, and a fifth character following the fourth character is not bindu or visargra.

61. The string display device of claim 34, wherein the microprocessor executes the execution program code to determine a cluster length of the received cluster; and
the microprocessor executes the execution program code to append a character of the received cluster to the resultant string, if the cluster length is not greater than one.

62. The string display device of claim 34, wherein the storage device further comprises:
a rule table comprising a plurality of entries, wherein for each Hindi character, the rule table contains at least an entry corresponding to the Hindi character, where the entry defines that a first string is mapped to a second string, and a first character of the first string is the Hindi character; and
the input buffer stores a cluster to be processed; and
the microprocessor executes the execution program code to process a target unprocessed character in the received cluster, search entries corresponding to the target unprocessed character for a target entry having a first string of a maximum number of characters matching a sequence of contiguous characters in the cluster where the target character is the first character of the sequence and append a second string of the target entry to the resultant string.

63. The string display device of claim 62, wherein the microprocessor executes the execution program code to exclude entries having a first string containing more characters than a sum of unprocessed characters in the cluster.

64. The string display device of claim 34, wherein the resultant string complies with Devanagari Script.

65. A ligature formatting device for converting an input string into a resulting string, comprising:
a storage device comprises:
an input buffer for storing an input string to be processed;
an execution program code; and
a rule table, comprising a plurality of entries, wherein for each character, the rule table contains at least an entry corresponding to the character, where the entry defines that a first string is mapped to a second string, and a first character of the first string is the character;
a microprocessor, coupled to the storage device, for executing the execution program code to search entries corresponding to the target unprocessed character for a target entry having a first string of a maximum number of characters matching a sequence of contiguous characters in the input string where the target character is the first character of the sequence; and then appending a second string of the target entry to the resultant string for each target unprocessed character in the input string.

66. The ligature formatting device of claim 65, wherein the microprocessor executes the execution program code to exclude entries having a first string containing more characters than a sum of unprocessed characters in the input string.
